(19) United States
(12) Patent Application Publication
(10) Pub. No.: US 2015/0356629 A1
(43) Pub. Date: Dec. 10, 2015

(54) MULTI-CHANNEL INFORMATION DISTRIBUTION PLATFORM

(71) Applicant: Mozido, Inc., Austin, TX (US)

(72) Inventors: Michael A. Liberty, Windermere, FL (US); Tiago Soromenho-Ramos, Bethesda, MD (US); Steve Bacastow, Cumming, GA (US)

(21) Appl. No.: 14/731,193

(22) Filed: Jun. 4, 2015

Related U.S. Application Data
(60) Provisional application No. 62/009,611, filed on Jun. 9, 2014.

(51) Int. Cl. G06Q 30/02; G06Q 20/20; G06Q 20/32; G06Q 20/24; G06Q 20/26; H04W 4/06; G06Q 20/34

(52) U.S. Cl. CPC G06Q 30/0271; H04W 4/06; G06Q 30/0268; G06Q 30/0267; G06Q 20/204; G06Q 20/352; G06Q 20/24; G06Q 20/26; G06Q 20/3278; G06Q 30/0226

(57) ABSTRACT

Embodiments are directed to providing targeted messages using a plurality of communication channels and to providing targeted messages to mobile devices. In one scenario, a computer system instantiates a multi-channel communication service that is configured to provide different targeted messages using multiple different communication channels. The computer system further determines that a targeted message is to be provided to a specified user through a first communication channel, and provides the targeted message through the first communication channel. The computer system also determines that the targeted message is to be provided to the specified user through a second, additional communication channel, and provides the targeted message through the second, different communication channel. The messages may include any type of content including text, pictures, videos, links or other content.

### CROSS-REFERENCE TO RELATED APPLICATIONS

This application claims priority to and the benefit of U.S. Provisional Application Ser. No. 62/009,611, entitled “MULTI-CHANNEL ADVERTISING PLATFORM”, filed on Jun. 9, 2014, which application is incorporated by reference in its entirety herein.

### BACKGROUND

Electronic devices have long been used to transfer messages between device users. These messages may be sent to an individual user, or may be sent to multiple users. Each of these messages includes data. In some cases, this data may be transaction data. The transaction data may be generated by a point of sale (POS) device. POS devices have long been used to facilitate transactions between customers and retailers. POS devices allow users to provide a means of payment (e.g. a credit or debit card) and, once the payment details have been received, facilitate processing of the transaction.

The POS may further allow the user to authenticate the transaction using a personal identification number (PIN) or by providing a signature. Some POS devices are designed to comply with the Europay, MasterCard and Visa (EMV) standard. Such devices allow users to use credit cards that are embedded with an integrated circuit (commonly known as “chip cards”). Such EMV-compliant POS devices allow the integrated circuit on the credit card to securely communicate credit card details through the POS to the backend transaction processing system.

### BRIEF SUMMARY

Embodiments described herein are directed to providing targeted messages using a plurality of communication channels and to providing targeted messages to mobile devices. In one embodiment, a computer system instantiates a multi-channel communication service that is configured to provide different targeted messages using multiple different communication channels. The computer system further determines that a targeted message is to be provided to a specified user through a first communication channel, and provides the targeted message through the first communication channel. The computer system also determines that the targeted message is to be provided to the specified user through a second, additional communication channel, and provides the targeted message through the second, different communication channel. The messages may include any type of content including text, pictures, videos, links or other content.

In another embodiment, an electronic device provides targeted messages to mobile devices. The electronic device receives an input indicating that a mobile device user is communicating with the electronic device. The electronic device includes a communication means for receiving data and further includes a display. The electronic device identifies, based on the received data, various characteristics corresponding to the mobile device user or to the received data. The electronic device then provides, on the electronic device's display, at least one targeted message which is targeted to the mobile device user based on the determined characteristics, and provides the same targeted message to the mobile device for display to the mobile device user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including providing targeted messages using a plurality of communication channels.

FIG. 2 illustrates an architecture in which offers are provided to users via a multi-channel offers platform.

FIG. 3 illustrates an alternative computer architecture in which embodiments described herein may operate including providing targeted messages using a plurality of communication channels.

FIG. 4 illustrates an embodiment in which targeted messages are provided to a user through a plurality of communication channels.

FIG. 5 illustrates a flowchart of an example method for providing targeted messages using a plurality of communication channels.

FIG. 6 illustrates a flowchart of an example method for providing targeted messages on a POS device.

### DETAILED DESCRIPTION

Embodiments described herein are generally directed to providing targeted messages on a plurality of channels and to providing targeted messages on a point of sale (POS) device. In one embodiment, a computer system performs a method for providing targeted messages on multiple different advertising or marketing channels. The method includes instantiating a multi-channel advertising service that is configured to provide different targeted messages to multiple different marketing channels. The method further includes determining that a targeted message is to be displayed to a specified user through a first marketing channel and displaying the targeted message through the first marketing channel, where the platform is configured to distribute content on at least a second, different marketing channel.

In another embodiment, a method is performed by a computer system. The method includes receiving an input indicating that a POS user is conducting a transaction using the POS device. The POS device includes a communication means for receiving transaction data, and further includes a display for displaying visual content. The method next includes determining, based on the received transaction data, various user characteristics corresponding to the POS user. Then, the method includes providing, on the POS display, at least one targeted message which is targeted to the user based on the determined user characteristics. This targeted message may be displayed to the POS user as the user is checking out at the point of sale.

In another embodiment, a method is performed by a computer system wherein a targeted message is encoded with one or more of an expiration date and maximum views. An information distribution platform may be configured to limit the number of times that a message can be distributed or viewed within a particular channel (POS, mobile device, eCommerce, etc.). The information distribution platform may also be configured to limit the number of times a message may be distributed to or viewed by a specific customer. The information distribution platform may also be configured to associate at least one expiration date with a message. A different expiration date may be associated with each channel for the same message. In this way, a targeted message may be available through a first expiration date for POS devices and a second expiration date for mobile devices. Similarly, the platform may be configured so that a message may be configured to be available for a given customer through a first expiration date and a second customer through a second expiration date. Alternatively, these limits may be combined in such a way as to limit the number of times a specific customer can view a specific message on a designated channel.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

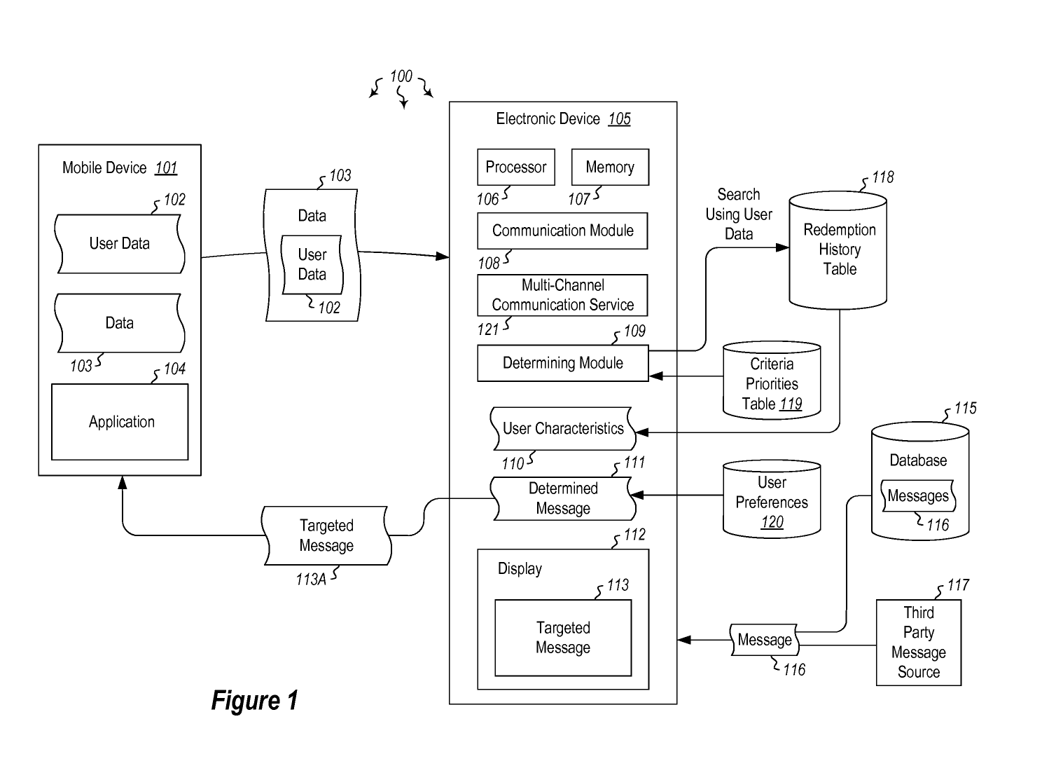

As illustrated in FIG. 1, a computing system (such as mobile device 101 or point of sale device 105) typically includes at least one processing unit 106 and memory 107. The memory 107 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 107 of the computing system. The computing system may also contain communication channels that allow the computing system to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 107. The system memory may also be referred to as “main memory”, and includes memory locations that are addressable by the at least one processing unit 106 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code. The computer-executable instructions may be embedded on an integrated circuit such as a field programmable gate array (FPGA) or other complementary metal-oxide-semiconductor (CMOS) type circuit. For example, the computer-executable instructions may be embedded on and/or run on a microcontroller or microprocessor.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes mobile device 101 and electronic device 105. Each of these devices may be mobile or stationary computing systems, and may be part of distributed (i.e. cloud) computing systems. The mobile device 101 may include various hardware modules for communicating with other computing systems. The mobile device 101 may, for example, communicate data 103 to the electronic device 105. In some cases, the data 103 may include user data 102. The user data 102 may include the user's preferences, characteristics of the user, past usage data or other information associated with a mobile device user.

In some embodiments, a mobile device user may use an application 104 to communicate with the electronic device 105. The user may use the application to provide the data 103 to the electronic device. The data 103 may include user data such as the user's name, home zip code, or possibly other demographic information such as age, education level, ethnicity, etc. Other user data 102 may include, for example, a listing of items previously purchased by the user at a merchant's store, status information such as loyalty level, rewards preferences from past redemptions, and/or predictive flags to identify a proclivity towards certain product or service categories. This user data may be used by the determining module 109 of the electronic device 105 to determine characteristics 110 and preferences 120 related to the user.

At least in some embodiments, determining module 109 is operable to search a redemption history table 118 to determine how similar users have responded to targeted messages in the past. Such a search may be optimized based on most important to least important user criteria as defined in the criteria priorities table 119. For example, a user's gender may be the most important criteria to use when selecting a message and user education level may be the second most important criteria to use. Using the characteristics 110 obtained from the search, the determining module 109 can determine which messages to display to the user. The determining module 109 may also look up user preferences 120 to determine if this specific user has registered any preferences regarding the types of messages that they prefer or do not prefer. The messages may, for example, notify the user of events taking place or things that are happening in that user's area. The messages may be tailored to the user based on the user data 102.

The electronic device 105 may receive the data 103 and/or user data 102 at the communication module 108 and pass that information to the determining module 109 where a specific message 111 will be selected based on the determined user characteristics 110. This targeted message 113 is then displayed to the user on display 112. The display 112 may be a touchscreen display that allows user interaction with the targeted message. The targeted message 113 may be displayed to the user at substantially any time, or at a specified time, or at a specified time interval. For instance, if the user is at a certain location, messages may begin to be displayed on display 112 after the user crosses a geofence or is otherwise determined to be in a certain area.

For example, the user's mobile device may communicate with other devices within a store or other area to determine whether the user is within a geofence. The user's mobile device may communicate via WiFi, Bluetooth, or global positioning system (GPS) radios embedded in the mobile device. The communications allow the device to determine its relative location on the earth or in relation to certain areas (such as a store or mall area). In one embodiment, targeted messages may be sent to the user based on the user's current location. In some cases, messages will be sent on one channel (e.g. a POS display) when the user is at a first location (e.g. at the store), and then sent on another channel (e.g. a mobile device app) when the user is at a second location (e.g. at home). Thus, the targeted message may be sent to the user on different communication channels depending on the location of the user. In some cases, the user data 102 may include an indication of where the user currently is or recently has been. This information may be used to determine which communication channel to use for a current message, and later on, which communication channel is to be used to send second, third, fourth or subsequent messages.

Alternatively, the targeted message 113 may be displayed after the user has performed a certain action or has performed a certain function within the application 104. The message 111 may include text, pictures, video or other data. This data may be pulled from a local or remote database 115 (which stores the stored messages 116) or from a third party message source 117 which may be accessible over a local network or over the internet using communication module 108.

Embodiments described in FIG. 1 as related to the electronic device may be deployed onto other devices such as a PC or remote computing device. For example determining module 109, user characteristics module 110, or other modules may each be deployed as a SaaS. In this way, the capabilities of these modules would be more generally available on different types of electronic devices.

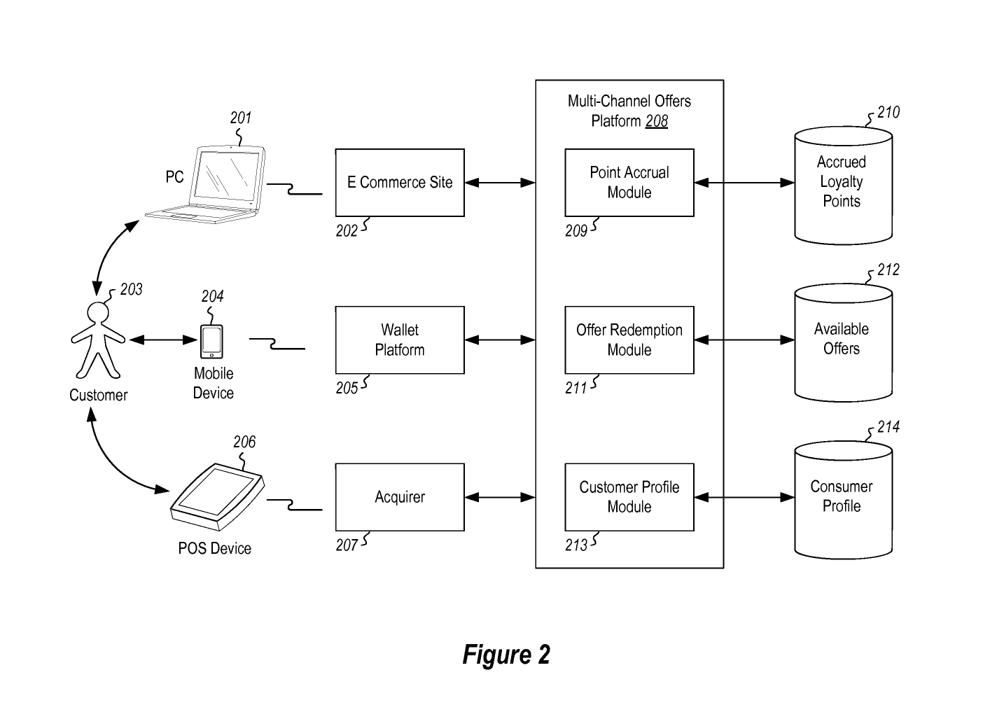

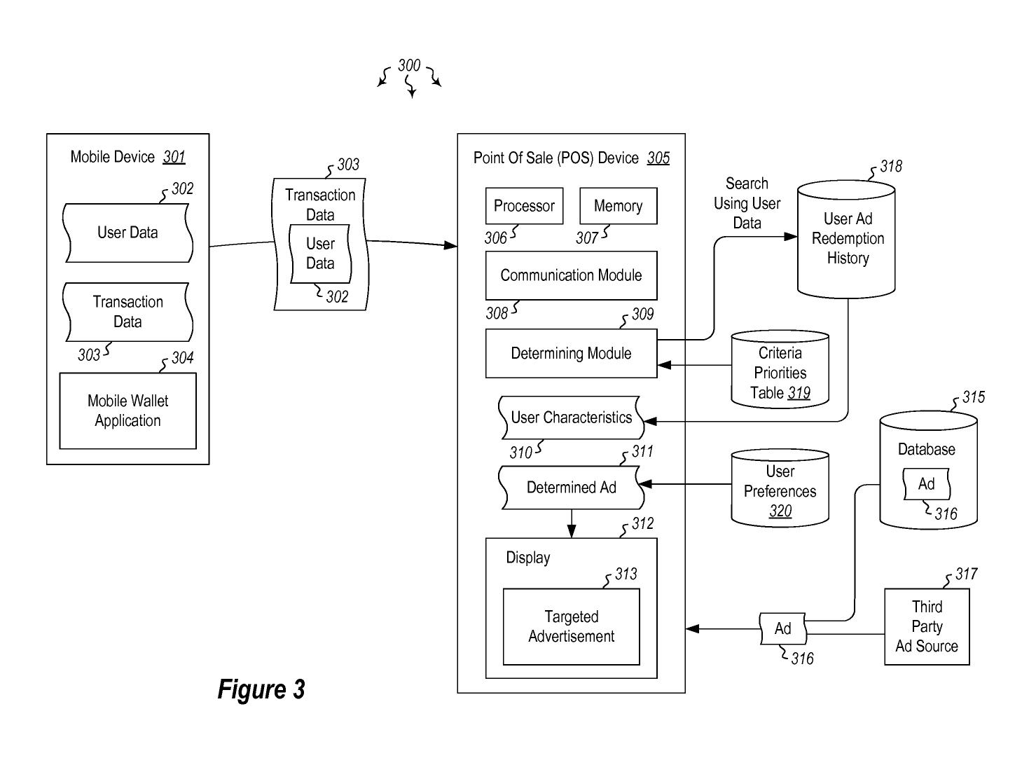

Turning now to FIG. 2, a computing environment is described in which targeted messages are provided on multiple different advertising or marketing channels. These marketing or advertising channels may include messages served on a mobile device (such as text, pictures and/or video) including a smartphone, tablet, laptop, wearable devices or other mobile computing system, on a POS device (such as POS device 305 described in FIG. 3 below), on a billboard, on television, on radio or any other advertising or marketing channel. As shown in FIG. 2, a customer 203 may interact with a personal computer (PC) laptop 201, a mobile device 204 and/or a POS device 206. The customer may be browsing or purchasing products from a store's website, as viewed on the PC 201 or on a mobile device 204, or may be purchasing products at a POS device 206 within a store.

For example, customer 203 may use their laptop to browse an e-commerce website 202. A multi-channel offers platform 208 may be instantiated on one or more computing systems (e.g. as a service within the cloud), and may be configured to keep track of the loyalty points accrued by the user. Accordingly, as the user shops and makes purchases at the e-commerce website, the point accrual module 209 of the multi-channel offers platform 208 may keep track of the user's accrued loyalty points 210. These loyalty points may then be used to receive discounts or other offers from the e-commerce website owner or provider. Similarly, a user such as customer 203 may use a mobile device 204 to purchase goods or services from a physical or online retailer using a mobile wallet. The mobile wallet may be part of wallet platform 205 which allows the mobile device 204 to interact with other computing systems and conduct transactions between the customer and the retailer.

In some embodiments, the user may have accrued loyalty points 210 which are to be applied during a purchase. Moreover, the offer redemption module 211 of the multi-channel offers platform 208 may determine that the user is eligible to receive one or more offers (such as coupons or buy-one-get-one-free offers), which may be applied to the current transaction or to later transactions. The offer redemption module 211 have access to a plurality of different available offers 212 which may be made available to certain customers based on certain conditions such as having a specified amount of loyalty points. Offers or advertisements may be based on past purchase history, wherein either recurring purchased items fall within a known pattern, or past purchased items may be relevant to the current purchased items. Offers may additionally include membership in loyalty or reward programs based upon non pre-existing membership.

Additionally or alternatively, offers may be made available to users that fit within a specified customer profile. The customer profile module 213 of multi-channel offers platform 208 may maintain a customer profile 214 for each customer that has shopped at their physical or online stores. Various demographics or user characteristics may also make the user eligible to receive one or more of the available offers 212. The acquirer 207 may, for instance, acquire information about the user based on their credit card (as explained above in relation to FIG. 1). This information may be used, in addition to any information already in the customer's profile 214, to determine which discounts or offers to provide, or which advertisements to display on the POS device 206.

In one embodiment, a computer system performs a method for providing targeted messages on multiple different advertising or marketing channels. The method includes instantiating a multi-channel advertising service (e.g. multi-channel offers platform 208) that is configured to provide different targeted messages (e.g. offers 212) to multiple different marketing channels (e.g. PC 201, mobile device 204 or POS device 206). The method further includes determining that a targeted message is to be displayed to a specified user (e.g. customer 203) through a first marketing channel, and displaying the targeted message through the first marketing channel, where the platform is configured to distribute content on at least a second, different marketing channel. As such, the platform may be configured to distribute content on a plurality of marketing channels.

The first marketing channel may be a POS device 206, while the second marketing channel is a website. As such, a retailer or other marketer may provide a message or offer to the multi-channel offers platform 208 and have the platform provide the message or offer to the customer 203 on the POS device 206 and also on a website 202 viewable on the user's PC 201 or mobile device 204. Similarly, in the embodiment above, the first marketing channel may be a POS device (e.g. the POS device 206 the user is using to check out at the store) and the second marketing channel is a mobile application. In such cases, the targeted message or offer 212 would be displayed to the user on the POS device and further provided to the user's mobile device 204 (e.g. within a mobile wallet application). Other combinations are also possible, including where the targeted message or offer 212 is provided to a mobile application and also to a website and/or POS device. As mentioned above, the POS device may be a Europay, MasterCard and Visa (EMV) POS device, or a traditional credit/debit card POS device.

In an exemplary embodiment, an in-store display screen either standalone or connected to a media control device may be combined with any of the previously mentioned primary channels (POS, Web, mobile app)). In this way, the in-store display may be considered a fourth channel for the purpose of making a targeted offer available to the consumer. The stand alone display screen may for example, notify the user that they have an offer waiting for them the next time that they shop online. A targeted video message may consist of an offer to join a loyalty or rewards program or other membership club related to the place of purchase or item or service purchased. An advantage of this method is that other nearby users may learn about available offers and offer programs and later subscribe to the program.

The targeted ads or offers may be shown or provided to the various channels simultaneously or separated by some amount of time. For instance, a message may be provided to the POS device while the user is checking out, and then later to the user's mobile device through a mobile application. Similarly, a targeted message or offer may be shown or provided to a user via an e-commerce website 202, and later when the user purchases or views the product using their mobile device 204, or later at the POS when the user shops at the physical store corresponding to (or selling the same goods as) the online store. Accordingly, targeted messages or offers may be provided to users on a variety of different channels, and may be distributed by the multi-channel offers platform 208. This platform may distribute ads or offers according to policies. These policies may indicate that certain customers or certain types or groups of customers are to be given certain offers. These offers may be based on prior purchases (e.g. purchases of a specific product or service), accumulation of loyalty points, a user's demographics or other profile data such as the type of credit card they use or (when accessible) their credit score or other credit report information.

FIG. 3 illustrates a computing environment 300 similar to that shown in FIG. 1. However, in the environment 300 of FIG. 3, the data 303 is transaction data sent from a mobile wallet application 304, the electronic device is a POS device 305, and the targeted messages are targeted messages 313. As in FIG. 1, FIG. 3 provides a computer architecture 100 with at least one mobile device 301 and a point of sale (POS) device 305. Each of these devices may be mobile or fixed computing systems, and may be part of distributed (i.e. cloud) computing systems. The mobile device 301 may, for example, communicate transaction data 303 to the POS device 305. The transaction data 303 may be data related to a specified transaction. For instance, if a mobile device user were using the mobile device 101 to make a purchase, the mobile device would transfer transaction data 303 to the POS device 305 as part of a monetary exchange between a user and a merchant.

A user may use a mobile wallet application 304 to conduct a transaction with a merchant. The user may use the mobile wallet application 304 to provide various forms of payment (e.g. credit or debit cards) to conduct the transaction with the merchant. If the user selects a certain form of payment (e.g. a credit card), that credit card's information (i.e. account number, expiration date, CVV, etc.) would be encrypted and transferred as part of the transaction data 303. As above, user data 302 data may also be included with the transaction data 303 including the user's name, home zip code, or possibly other demographic information such as age, education level, gender, etc. Other user data 302 may include a listing of items previously purchased by the user at that merchant's store, an accrual of loyalty points, rewards preferences from past redemptions, and/or predictive flags to identify tendencies towards certain products. This user data may be used by the determining module 309 of the POS device 305 to determine characteristics 310 and preferences 320 related to the user.

At least in some embodiments, determining module 309 is operable to search a user ad redemption history table 318 to determine how similar uses have responded to targeted ads in the past. For example, the ad redemption history table may store information indicating which users responded to which ads, which users were interested in similar products or events, and which users actually purchased products or services in response to those ads. The search may be optimized based on certain criteria. For instance, the criteria priorities table 319 may indicate search criteria for identifying ads, products, services, events or other information stored in the ad redemption history table 318. In one example, user gender may be the most important criteria to use when selecting an advertisement and user education level may be the second most important criteria to use. Using the results obtained from the search, the determining module 309 can determine which ads to display to the user. The determining module 309 may also look up user preferences 320 to determine if this specific user has registered any preferences regarding the types of ads that they prefer or do not prefer.

The POS device 305 may receive the transaction data 303 and/or user data 302 at the communication module 308 and pass that information to the determining module 309 where a specific ad or message 311 will be selected based on the determined user characteristics 310. This targeted ad 313 is then displayed to the user on display 312. The display 312 may be a touchscreen display that allows interaction with the targeted ad or message, if the user so desires. The targeted message 313 may be displayed to the user before the user enters a form of payment, after the user enters a form of payment, or at any time during the checkout process. For instance, if the user is at a grocery store, ads may begin to be displayed on display 312 after the user's first item is scanned by the checker. Alternatively, the targeted message 313 may be displayed after the user has swiped a credit or debit card or provided payment via a mobile wallet 304. The message may include text, pictures, video or other media. This media may be pulled from a local or remote database 315 (which stores the stored ads or messages 316) or from a third party message source 317 which may be accessible over a local network or over the internet using communication module 308.

In one embodiment, a method is described which provides targeted messages on a point of sale (POS) device. The method includes receiving an input indicating that a POS user is conducting a transaction using the POS device. The POS device 305 may thus receive transaction data 303 or some other input indicating that a POS device user (e.g. a customer at a merchant's store) is using the POS device to pay for one or more items. The POS device including a communication means 108 for receiving transaction data, and further includes a display 312. The communication means may include any type of wired or wireless radio (e.g. WiFi, Bluetooth or other radio configured to receive and transmit data). The determining module 309 of the POS device 305 may then determine, based on the received transaction data 303 and/or user data 302, one or more user characteristics 310 corresponding to the POS user. Then, the POS display 312 may provide at least one targeted message 313 which is targeted to the user based on the determined user characteristics 310.

The POS device 305 may be Europay, MasterCard and Visa (EMV) compatible. As such, transactions conducted using the POS device 305 may be authenticated using the EMV authentication standard. The EMV standard facilitates the use of chip cards by allowing secure, encrypted transfer of transaction details between an integrated circuit in the user's credit card and the POS device 305. Thus, in some cases, a user may interact with the POS device 105 without the use of mobile device 301. Indeed, the user may simply swipe their credit card or place the chip card within sufficient proximity of the POS device to read the encrypted card data including some portions of the user's data 302 (e.g. name, zip code, etc.).

Once the POS device has initiated the processing of the transaction, the determining module 309 can glean whatever information is available about the user and similar users (the amount of user information may vary depending on the credit/debit card provider) and, based on that user data 302, may determine characteristics about the user 310. These characteristics may, for instance, provide an idea of the type of products the user buys or may be interested in, based on their age (or age range), credit card type (e.g. more exclusive credit cards may elicit different types of ads), ethnicity (certain types of food or other products may be more appealing to certain ethnicities), or other information.

The targeted message itself may be a video message, an image, an audio message, a text-based message, or a combination of any of these, static or interactive. In some cases, the targeted ad or message is related to one or more items that are being purchased by the POS device user as part of the transaction. Thus, if the user is purchasing a shirt and shorts, the merchant may wish to promote a special on hats, sunglasses or footwear, or may wish to promote a two-for-one special on shirts of a certain brand. Accordingly, the messages may be targeted to the user based on user characteristics, based on items currently being purchased, items purchased in the past, or a combination of any of these.

Thus, for example, a user may initiate checkout for a variety of goods. The user may swipe their credit or debit card or may place the integrated circuit portion of a credit or debit card within proximity of the POS device 305. The POS device 305 may then display a targeted message or ad 313 is displayed to the user. This targeted message may provide a discount on one or more items available at that merchant or available at surrounding merchants (e.g. other stores within a mall or within a fixed distance from the merchant (or adjacent to the merchant) such as surrounding restaurants or theaters). These other merchants may promote current promotions or specials they are having on goods that the user would be more likely to be interested in based on the determined user characteristics 310. In cases where the user is using a mobile wallet application 304 to conduct the transaction, the POS device may transfer a coupon or other offer directly to the user's mobile wallet for use at a later time (or in the current transaction). Thus, a mobile wallet user may receive rewards or other offers for being a loyal customer or for using a specific credit card. These rewards may be transferred automatically to the user as part of the targeted message, or as a reward for viewing the targeted message 313.

The point of sale (POS) device itself may be an EMV-compliant device or may be a more traditional non-EMV-compliant device. EMV-compliant POS devices are capable of conducting transactions by receiving account information transferred wirelessly from an integrated circuit embedded in the credit card to the communication module 108 of the POS device. Non-EMV-compliant devices are configured to conduct transactions by receiving account information from a card swipe. Either type of POS device may be capable of conducting transactions with a mobile wallet application 104.

The POS device may include a processor 306, memory 307, a communication module 308 for receiving an input indicating that a POS device user is conducting a transaction using the POS device, a determining module 309 for determining, based on received transaction data, one or more user characteristics 310 that correspond to the user, and a display 312 for displaying at least one targeted message 313 which is targeted to the user based on the determined user characteristics. In this manner, the POS device 305 is configured to receive transaction data (whether from a mobile wallet, from a card swipe, from a manual card number entry, from a chip in a chip card, or from some other source), conduct a transaction, and display a targeted message to the user during the course of the transaction.

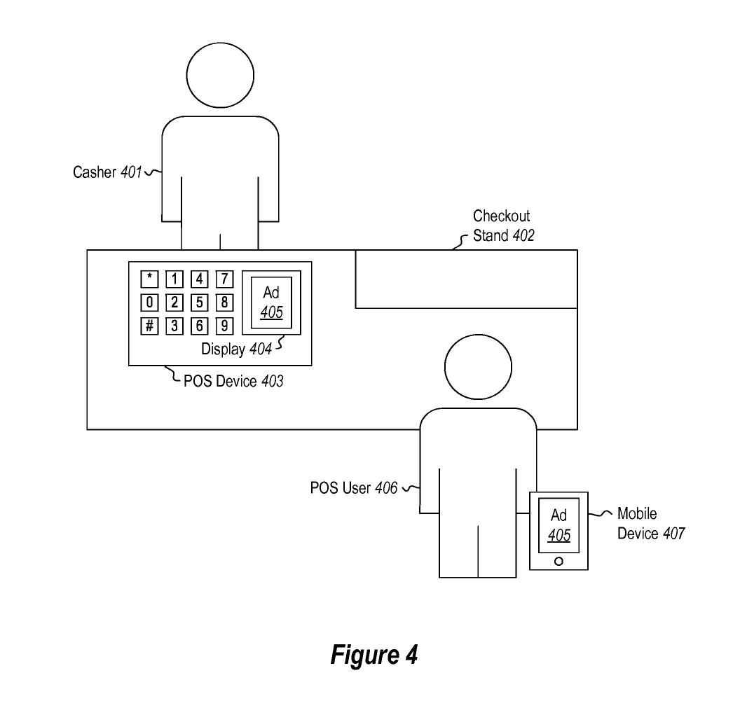

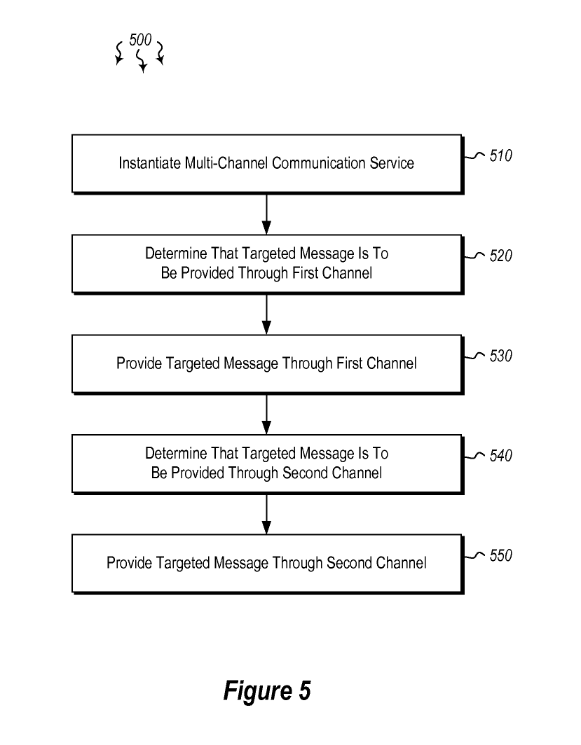

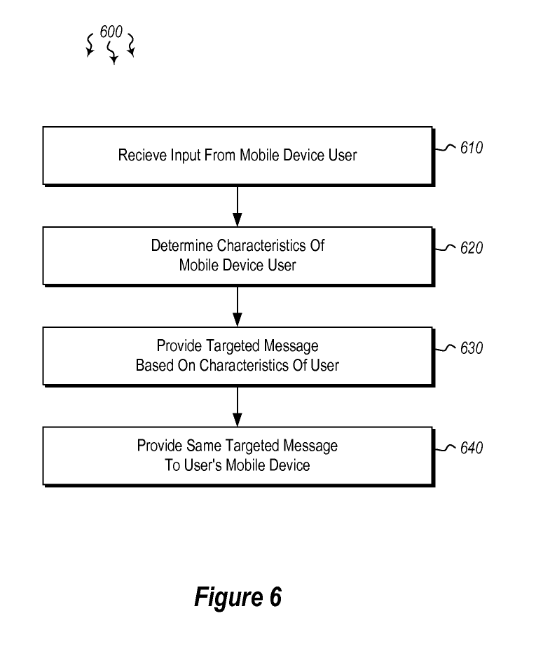

The computing architecture 300 described in FIG. 3 as related to the POS device 305 device may be deployed onto other devices such as a PC or remote computing device. For example, the communication module 308, the determining module 309, and other modules may each be deployed as a SaaS. In this way, the capabilities of these modules would be more generally available POS and non-POS devices. FIG. 4 illustrates an embodiment in which the same message or advertisement is shown on different devices. This embodiment will be described in the context of methods 500 and 600 of FIGS. 5 and 6 below.

FIG. 5 illustrates a flowchart of a method 500 for providing targeted messages using a plurality of communication channels. The method 500 will now be described with frequent reference to the components and data of environment 100 of FIG. 1.

Method 500 includes instantiating a multi-channel communication service that is configured to provide different targeted messages using a plurality of different communication channels (510). For example, the electronic device 105 may instantiate a multi-channel communication service 121 that provides targeted messages to users over different communication channels. The targeted messages may include various types of content including information about events, products or services. Additionally or alternatively, the messages may be personal messages sent from user to user. The different communication channels may include different means that can be configured to provide or display messages including, for example, a mobile device, a POS device, an application (e.g. a mobile wallet application), a website, a billboard or other type of communication channel.

Method 500 further includes determining that a targeted message is to be provided to a specified user through a first communication channel (520). For example, the determining module 109 may determine that targeted message 111 is to be provided to a mobile device user. This message may then be provided to the user through the first communication channel (530). As shown in FIG. 4, if the targeted message is an advertisement, and the user is at a point of sale, the POS user 406 may see the ad 405 on the display 404 of the POS device 403.

Method 500 further includes determining that the targeted message is to be provided to the specified user through a second, additional communication channel (540), and providing the targeted message through the second, different communication channel (550). The determining module 109 may determine that the targeted message is to be displayed on the POS user's mobile device 407. The advertisement 405 may then also be displayed on the mobile device 407. The advertisement (or other targeted message) may be the same ad, or may be a different ad. Thus, in this manner, a promoter may provide an ad or message when the POS user swipes their credit card at the POS, and the promoter may provide the same or a different ad or message via another channel such as the user's mobile device. While two communication channels are mentioned in method 500, it will be understood that substantially any number of communication channels may be used in the embodiments herein. The communication channels may send the targeted messages simultaneously or sequentially, on any number of channels that are available.

In some embodiments, the first communication channel may be a POS device, and the second communication channel may be a website. Thus, the user may see a message at the POS, and the promoter may also provide that same message or a related message, or another targeted message to the user via a website that the user is viewing. In another example, the first communication channel may be a POS device and the second communication channel may be a mobile application. In this case, the user may see an message at the POS, and the promoter may also provide that same message or a related message, or another targeted message to the user via a mobile application that the user is viewing such as a mobile wallet application.

This pattern may be repeated for other communication channels including the following: the first communication channel may be a mobile application and the second communication channel may be a website, the first communication channel may be a mobile application and the second communication channel may be a POS device, the first communication channel may be a website and the second communication channel may be a mobile application, or the first communication channel may be a website and the second communication channel may be a POS device.

It will be understood that other communication channels may be used, and that the above-provided examples are not intended to be an exhaustive list of possible communication channels or combination of usable channels. It will be further noted that the targeted message 113 may be targeted to the user based on any one or a combination of demographics associated with that user. The message may also be targeted to the user based on past purchases or past interactions with users or other messages. The targeted message 113A may be the same message as message 113 shown in display 112, or may be a different message. The targeted message 113A is sent to mobile device 101 for display on the mobile device.

In another embodiment, a method is performed by a computer system wherein a targeted message is encoded with one or more of an expiration date and maximum views. An information distribution platform (e.g. the multi-channel communication service 121) may be configured to limit the number of times that a message can be distributed or viewed within a particular channel (POS, mobile device, eCommerce, etc.). For example, the information distribution platform may indicate that a specific targeted message may only be distributed to or viewed on a POS channel 5, 10, 50, 100 or some other number of times before the targeted message is no longer shown. Similar limits may be applied to other distribution channels.

The information distribution platform may also be configured to limit the number of times a message may be distributed to or viewed by a specific customer. Thus, as in the example above, the information distribution platform may indicate that a specific targeted message may only be distributed to or viewed by a specific customer 1, 2, 3, 5, or some other number of times before the targeted message is no longer shown to that customer. The information distribution platform may also be configured to associate at least one expiration date with a message. A different expiration date may be associated with each channel for the same message. In this way, a targeted message may be available through a first expiration date for POS devices and a second expiration date for mobile devices. The same is true for other distribution channels, such that, for each targeted message, an expiration date may apply for that message and for each distribution channel separately.

Similarly, the platform may be configured so that a message may be configured to be available for a given customer through a first expiration date and a second customer through a second expiration date. Alternatively, these limits may be combined in such a way as to limit the number of times a specific customer can view a specific message on a designated channel. For example, the platform may be configured to allow Customer A to view a first message using the Customer's mobile device up to 5 times through a first expiration date while Customer B is allowed to view the same message one time through a second expiration date, the second date associated with a POS device. In this way, the platform is fully configurable with regard to limiting the distribution of messages to customers and channels.

Turning now to FIG. 6, a flowchart is illustrated of a method 600 for providing targeted messages to mobile devices. The method 600 will now be described with frequent reference to the components and data of environment 300 of FIG. 3.

Method 600 includes receiving an input indicating that a mobile device user is communicating with the electronic device, the electronic device including a communication means for receiving data and further including a display (610). For example, POS device 305 may receive an input (e.g. transaction data 103) from mobile device 301. The POS device includes a communication module 108 for receiving data, as well as a display 112. The determining module 109 may identify, based on the received data, one or more characteristics corresponding to the mobile device user or to the received data (620). The characteristics of the user may include demographic information, information about the user's preferences, information about the user's past purchases or other information related to the user. Similarly, the characteristics corresponding to the data may include the type of data, the data structure, data related to other users or other merchants, or other information.

Method 600 includes providing, on the electronic device's display, at least one targeted message which is targeted to the mobile device user based on the determined characteristics (630), and providing the same targeted message to the mobile device for display to the mobile device user (640). The same targeted message (such as targeted message 313) may be sent to the electronic device (such as POS device 305) and the mobile device 301 at the same time or at a later time. Similarly, as shown in FIG. 2, the targeted message may be sent to a POS and a website, or a POS and a mobile phone app, or to a website and an app, or to a website and a POS, or to any other devices or applications through any of a variety of communication channels. Indeed, while POS display, website, application, mobile device and billboard are mentioned as examples of communication channels, it will be understood that other communication channels may also be used. The channels may be used individually or together, and any number of communication channels may be used, either in sequence or simultaneously. The multi-channel communication service may communicate the same message or message to a plurality of different devices, simultaneously or at different times.

In some cases, the targeted message is a video message. The targeted video message may be related to various items that are being purchased by a POS device user as part of a transaction. For instance, as shown in FIG. 4, a POS user 406 may be at a checkout stand 402 checking out with various items the user wishes to purchase. The cashier 401 may scan the user's items, after which the total amount for the items will be displayed by the POS device 403. When the total is displayed, (or before or after the total is displayed), the POS device 403 may display a video message or advertisement 405 on its display. The same message or ad 405 may (simultaneously or thereafter) be displayed on the POS user's mobile device 407. Additionally or alternative, the same ad or message 405 may be displayed on a website or app viewed by the POS user. Still further, a billboard or other in-store display screen in the general area of the user may display the same ad or message to the user to ensure that the user sees the ad or message. The in-store display screen may be used as an available communication channel to display an offer. The in-store display screen may be a standalone display or a display connected to a media control device.

A targeted video message may be targeted to a POS device user based on at least one user characteristic and further based on at least one item being purchased by the POS device user as part of a transaction. The messages or ads may thus be related to or may complement those being purchased by the user. The targeted message may be displayed to the user upon determining that the user has placed an integrated circuit portion of a credit or debit card within proximity of the POS device. As mentioned above, chip cards typically include an integrated circuit portion that securely communicates with the POS device 403. In cases where a user places a chip card within a sufficient proximity of the POS device, the POS device may communicate with the chip card to carry out the transaction. Once such communication has begun, the targeted message may be displayed on the POS device's display. The POS device may be one of many different possible electronic devices with which the mobile device 301 may communicate.

In at least one embodiment, an electronic device may be provided which includes at least one hardware processor, system memory, a communication module for receiving an input indicating that a mobile device user is communicating with the electronic device, where the communication module is configured to receive data, a determining module for determining, based on the received data, various characteristics that correspond to the mobile device user or to the received data, and a display for displaying at least one targeted message which is targeted to the user based on the determined characteristics, where the communication module provides the same targeted message to the mobile device for display to the mobile device user. The electronic device may be a point of sale (POS) device, and that POS device may be Europay, MasterCard and Visa (EMV) compatible.

In some cases, a targeted message may be a message that is related to items that are being purchased by a POS device user as part of a transaction. In such cases, the targeted message may include an offer to join a loyalty or rewards program or other membership club related to the place of purchase or item or service purchased. In this manner, targeted offers may be provided to users on a variety of different channels. Each of these channels may provide the message or ad in a different manner which conforms to the given medium. Moreover, the message may tailored to the user, and may be provided at a time when the user is likely to use the offered product or service.

Accordingly, methods, systems and computer program products are provided which provide targeted messages on multiple different marketing channels. Moreover, methods, systems and computer program products are provided which provide targeted messages on a point of sale device. Still further, a point of sale device is provided which displays targeted messages which are targeted to a user based on determined user characteristics or other information about the user as stored in a user profile.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A method, implemented at a computer system that includes at least one processor, for providing targeted messages using a plurality of communication channels, the method comprising:
instantiating a multi-channel communication service that is configured to provide different targeted messages using a plurality of different communication channels;
determining that a targeted message is to be provided to a specified user through a first communication channel;
providing the targeted message through the first communication channel;
determining that the targeted message is to be provided to the specified user through a second, additional communication channel; and
providing the targeted message through the second, different communication channel.

2. The method of claim 1, wherein the first communication channel comprises a point of sale (POS) device and wherein the second communication channel comprises a website.

3. The method of claim 1, wherein the first communication channel comprises a POS device and wherein the second communication channel comprises a mobile application.

4. The method of claim 1, wherein the first communication channel comprises a mobile application and wherein the second communication channel comprises a website.

5. The method of claim 1, wherein the first communication channel comprises a mobile application and wherein the second communication channel comprises a POS device.

6. The method of claim 1, wherein the first communication channel comprises a website and wherein the second communication channel comprises a mobile application.

7. The method of claim 1, wherein the first communication channel comprises a website and wherein the second communication channel comprises a POS device.

8. The method of claim 1, wherein the targeted messages are targeted to the specified user based on one or more demographics associated with the specified user.

9. A method, implemented at an electronic device that includes at least one processor, for providing targeted messages to mobile devices, the method comprising:
receiving an input indicating that a mobile device user is communicating with the electronic device, the electronic device including a communication means for receiving data and further including a display;
identifying, based on the received data, one or more characteristics corresponding to the mobile device user or to the received data;
providing, on the electronic device's display, at least one targeted message which is targeted to the mobile device user based on the determined characteristics; and
providing the same targeted message to the mobile device for display to the mobile device user.

10. The method of claim 9, wherein the electronic device comprises a point of sale (POS) device.

11. The method of claim 9, wherein the targeted message comprises a video message.

12. The method of claim 11, wherein the targeted video message is related to one or more items that are being purchased by a POS device user as part of a transaction.

13. The method of claim 11, wherein the targeted video message has an associated expiration date for each channel on which the targeted video message is distributed.

14. The method of claim 10, wherein the targeted message is displayed to the user upon determining that the user has placed an integrated circuit portion of a credit or debit card within proximity of the POS device.

15. An electronic device, comprising:
one or more processors;
system memory;
a communication module for receiving an input indicating that a mobile device user is communicating with the electronic device, wherein the communication module is configured to receive data;
a determining module for determining, based on the received data, one or more characteristics that correspond to the mobile device user or to the received data;
a display for displaying at least one targeted message which is targeted to the user based on the determined characteristics; and
wherein the communication module provides the same targeted message to the mobile device for display to the mobile device user.

16. The electronic device of claim 15, wherein the electronic device comprises a point of sale (POS) device, and wherein the POS device is Europay, MasterCard and Visa (EMV) compatible.

17. The electronic device of claim 16, wherein the targeted message comprises a message that is related to one or more items that are being purchased by a POS device user as part of a transaction.

18. The electronic device of claim 17, wherein the targeted message is displayed to a POS user upon determining that the POS user has placed an integrated circuit portion of a credit or debit card within proximity of the POS device.

19. The electronic device of claim 17, wherein the targeted message comprises an offer to join a loyalty or rewards program or other membership club related to the place of purchase or item or service purchased.

20. The electronic device of claim 15, wherein an in-store display screen is used as an available communication channel to display the available offer, the in-store display screen comprising a standalone display or a display connected to a media control device.
